(19) United States
(12) Patent Application Publication
(10) Pub. No.: US 2026/0266961 A1
(43) Pub. Date: Sep. 10, 2026

(54) LIDAR DEVICE, COLLIMATION SYSTEM, AND COLLIMATION METHOD THEREFOR

(71) Applicant: AUTOX TECH PTE. LTD., SINGAPORE (SG)

(72) Inventors: Zhuo Li, Shenzhen (CN); Chunting He, Shenzhen (CN)

(73) Assignee: AUTOX TECH PTE. LTD., SINGAPORE (SG)

(21) Appl. No.: 19/257,472

(22) Filed: Jul. 2, 2025

(30) Foreign Application Priority Data
Mar. 7, 2025 (CN) 2025102761344

(51) Int. Cl. G01S 7/481; G01S 17/89

(52) U.S. Cl. CPC G01S 7/4815; G01S 7/4817; G01S 17/89

(57) ABSTRACT

The disclosure provides a LiDAR device including: an emitting circuit board, having a front surface and a back surface opposite to the front surface; a plurality of lasers, arranged on the front surface; and a collimating lens, positioned adjacent to the front surface and spaced apart from the plurality of lasers by a predetermined distance; the plurality of lasers oriented towards the collimating lens, with the axial length of the collimating lens being greater than the distance between any two adjacent lasers, such that when the plurality of lasers emit laser beams, a spot array is formed via the collimating lens; and the collimating lens being coupled to the emitting circuit board by a fixing member secured to the back surface. Furthermore, the disclosure also provides a collimation system and a collimation method for the LiDAR device.

### CROSS REFERENCE TO RELATED APPLICATION

This non-provisional patent application claims priority under 35 U.S.C. §119 from Chinese Patent Application No. CN 2025102761344 filed on Mar. 7, 2025. the entire content of which is incorporated herein by reference.

### TECHNICAL FIELD

The present invention relates to the field of laser technology, and more particularly to a LiDAR device, and a collimation system and a collimation method therefor.

### BACKGROUND

Current semiconductor lasers sources for LiDAR systems predominantly include edge-emitting lasers (EELs) and vertical cavity surface emitting lasers (VCSELs). Generally, semiconductor lasers exhibit inherent beam divergence angles ranging from 10° to 30° (full width at half maximum). Specifically for EELs, the divergence characteristics are anisotropic, presenting distinct fast-axis (typically 25°) divergence profiles. Therefore, it is necessary to perform collimation on the laser.

While individual lasers may be collimated using dedicated fast-axis collimator (FAC) lenses, this approach becomes impractical for high-density laser arrays. The conventional one-to-one collimation method introduces critical manufacturing challenges including: difficulties in glue dispensing, high process complexity, and high time cost.

### SUMMARY

In view of the above, the disclosure provides a LiDAR device, and a collimation system and a collimation method therefor, to achieve simultaneous collimation of multiple lasers and reduce the difficulty of fixing the collimating lens.

In a first aspect, the disclosure provides a LiDAR device, A LiDAR device, wherein the LiDAR device includes: an emitting circuit board, having a front surface and a back surface opposite to the front surface; a plurality of lasers, arranged on the front surface; and a collimating lens, positioned adjacent to the front surface and spaced apart from the plurality of lasers by a predetermined distance; the plurality of lasers oriented towards the collimating lens, with the axial length of the collimating lens being greater than the distance between any two adjacent lasers, such that when the plurality of lasers emit laser beams, a spot array is formed via the collimating lens; and the collimating lens being coupled to the emitting circuit board by a fixing member secured to the back surface.

In a second aspect, the disclosure provides a collimation system for a LiDAR device, configured to collimate the LiDAR device. The collimation system includes: an image acquisition device, configured to acquire a spot image corresponding to the spot array formed by laser beams emitted by the plurality of lasers, the spot image being configured to collimate the plurality of lasers according to predetermined collimation conditions; an adjustment frame, on which the collimating lens is mounted, configured to drive the collimating lens to move and/or rotate relative to the plurality of lasers; and a controller, communicatively connected to the adjustment frame and the image acquisition device respectively; the controller controlling movement of the adjustment frame based on the spot image to drive the collimating lens to move and/or rotate relative to the plurality of lasers, thereby adjusting the spot array.

In a third aspect, the disclosure provides a collimation method for a LiDAR device, the collimation method includes: acquiring a spot image of the plurality of lasers by an image acquisition device; adjusting a position and an angle of the collimating lens relative to the plurality of lasers based on the spot image until spot arrays corresponding to the plurality of lasers all satisfy predetermined alignment conditions; and fixing the collimating lens to the back surface of the emitting circuit board by the fixing member.

The above LiDAR device, the collimation system, and collimation method therefor arrange the plurality of lasers on the front surface of the emitting circuit board, and adjust the position and angle of the collimating lens relative to the plurality of lasers, so as to achieve simultaneous collimation of multiple lasers through one collimating lens. When the collimating lens achieves collimation of the plurality of lasers, the collimating lens is fixed to the back surface of the emitting circuit board. Since only one collimating lens needs to be fixed without considering the influence on the plurality of lasers, the difficulty of fixing the collimating lens is reduced, thereby reducing time cost.

### BRIEF DESCRIPTION OF THE DRAWINGS

To more clearly illustrate technical solutions in the embodiments of the disclosure or in the prior art, the following will briefly introduce drawings to be used in descriptions of the embodiments or the prior art. It is apparent that the drawings described below are merely some embodiments of the disclosure, and those of ordinary skill in the art can obtain other drawings based on the structures shown in these drawings without creative efforts.

FIG. 1 is a schematic side view of an emitting circuit board with a collimating lens according to an embodiment.

FIG. 2 is a schematic front view of an emitting circuit board with a collimating lens according to an embodiment.

FIG. 3 is a schematic front view of a LiDAR device according to an embodiment.

FIG. 4 is a schematic electrical connection diagram of a collimation system of a LiDAR device according to an embodiment.

FIG. 5 is a first schematic diagram of a spot image according to an embodiment.

FIG. 6 is a second schematic diagram of a spot image according to an embodiment.

FIG. 7 is a third schematic diagram of a spot image according to an embodiment.

FIG. 8 is a schematic flowchart of a collimation method of a LiDAR device according to an embodiment.

### REFERENCE NUMERALS IN THE FIGURES

LiDAR Device 1; Receiving Mirror 17; Circuit Board 11; Lens 18; Emitting Circuit Board 11; Receiving Circuit Board 19; Front Surface 111; Collimation System 2; Back Surface 112; Image Acquisition Device 21; Laser 12; Controller 22; Collimating Lens 13; Adjustment Frame 23; Fixing Member 14; Driving Device 231; Emitting Mirror 15; Clamp 232; Aperture Mirror 16.

The realization of the objective, functional features, and advantages of the disclosure will be further described below with reference to the embodiments and the drawings.

### DETAILED DESCRIPTION OF THE EMBODIMENTS

In order to make the purpose, technical solution, and advantages of this application clearer and clearer, the following will provide further detailed explanations of this application in conjunction with the accompanying drawings and embodiments. It should be understood that the specific embodiments described here are only intended to explain the disclosure and are not intended to limit the disclosure. Based on the embodiments in this application, all other embodiments obtained by ordinary technical personnel in this field without creative labor fall within the scope of protection of this application.

The terms “first,” “second,” “third,” “fourth,” etc. (if present) in the specification, claims, and accompanying drawings of the disclosure are used to distinguish similar planning objects and are not necessarily used to describe a specific sequence or order. It should be understood that such terms, when used, may be interchangeable under appropriate circumstances. In other words, the described embodiments may be implemented in an order other than that illustrated or described herein. Furthermore, the terms “include” and “have” and any variations thereof may also encompass additional content. For example, a process, method, system, product, or device comprising a series of steps or units is not limited to only those steps or units clearly listed but may include other steps or units not clearly listed or inherent to those processes, methods, products, or device.

It is important to note that the descriptions involving “first,” “second,” etc., in the disclosure are solely for descriptive purposes and should not be understood as indicating or implying their relative importance or implicitly specifying the number of indicated technical features. Therefore, features qualified by “first,” “second,” etc., may explicitly or implicitly include one or more of such features. In addition, the technical solutions among the various embodiments may be combined with each other, but this must be based on the ability of ordinary skilled artisans in the field to achieve such combinations. When the combination of technical solutions contradicts each other or cannot be implemented, such combinations should be deemed non-existent and not within the scope of protection claimed in the disclosure.

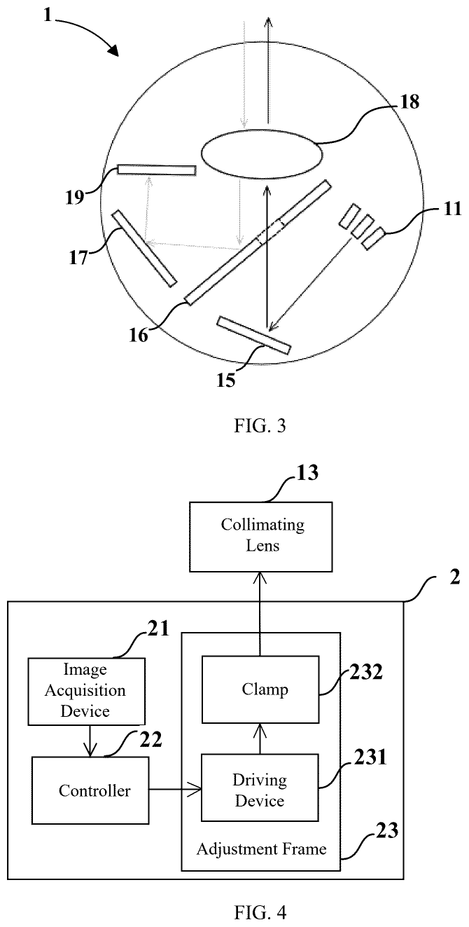

Referring to FIG. 3, FIG. 3 is a schematic front view of a LiDAR device according to an embodiment. The disclosure provides a LiDAR device 1, including an emitting circuit board 11, an emitting mirror 15, an aperture mirror 16, a receiving mirror 17, a lens 18, and a receiving circuit board 19. A beam emitted by the emitting circuit board 11 is transmitted to the emitting mirror 15, reflected by the emitting mirror 15, and then directly passes through the aperture mirror 16, and then passes through the lens to form an emitted beam emitted to a target object. The emitted beam is reflected by the target object to form a received beam. The received beam passes through the lens and is transmitted to the aperture mirror 16, reflected by the aperture mirror 16, and then transmitted to the receiving mirror 17, and finally reflected by the receiving mirror 17 and transmitted to the receiving circuit board 19. Among them, some beams emitted by the emitting circuit board 11 have a large divergence angle, so it is necessary to collimate the beams emitted by the emitting circuit board 11.

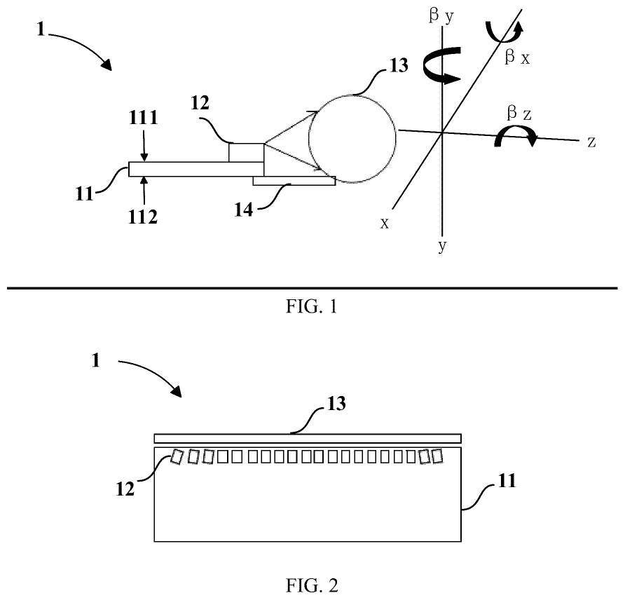

Referring to FIG. 2, FIG. 2 is a schematic front view of an emitting circuit board with a collimating lens according to an embodiment. The LiDAR device 1 further includes a plurality of lasers 12 disposed on the emitting circuit board 11, a collimating lens 13 disposed adjacent to one side of the emitting circuit board 11, and a fixing member 14 for fixing the collimating lens 13 to the emitting circuit board 11, so as to achieve collimation of multiple lasers 12 through one collimating lens 13. In this embodiment, the number of lasers 12 is plural, and the number of lasers 12 can be set as needed, which is not limited herein. In this embodiment, all of the plurality of lasers are edge-emitting lasers. The plurality of lasers 12 are mounted on the emitting circuit board 11 according to theoretical positions to ensure that the position of each laser 12 meets design requirements. Among them, the relative positional accuracy between each adjacent pair of lasers is less than a predetermined positional accuracy. The predetermined positional accuracy is an error between a theoretical relative distance and an actual relative distance between one laser and another laser. The predetermined positional accuracy can be set as needed, and preferably, the predetermined positional accuracy is ±20 μm.

Referring to FIG. 1, FIG. 1 is a schematic side view of an emitting circuit board with a collimating lens according to an embodiment. The emitting circuit board 11 includes a front surface 111 and a back surface 112 opposite to the front surface 111. The plurality of lasers 12 are arranged in parallel along the setting direction of the collimating lens 13 on one side of the front surface 111, with each laser 12 forming an initial angle with the collimating lens 13. The collimating lens 13 is disposed adjacent to the side of the emitting circuit board 11 where the plurality of lasers 12 are arranged, maintaining a certain distance from the emitting circuit board 11. The plurality of lasers 12 are oriented towards the collimating lens 13, so that laser beams emitted by the plurality of lasers 12 form a spot array after passing through the collimating lens 13. When the collimating lens 13 achieves collimation of the plurality of lasers 12, an end of the collimating lens 13 away from the front surface 111 is fixed to the back surface 112 of the emitting circuit board 11 by the fixing member 14. It can be understood that the initial angle is an angle formed between a laser beam emitted by each laser 12 and an optical axis of the collimating lens before the collimating lens 13 is adjusted. Initial angles between different lasers 12 and the collimating lens 13 may be equal or unequal, and the initial angle may be a right angle or any other angle.

In this embodiment, the relative angle between the collimating lens 13 and each laser 12 is adjusted by controlling movement and/or rotation of the collimating lens 13, thereby ensuring collimation of laser beams of each laser 12. Among them, the number of collimating lenses 13 is one, and the axial length of the one collimating lens 13 is greater than the distance between any two adjacent lasers, so as to achieve simultaneous collimation of multiple lasers 12 through one collimating lens 13. In addition, a shape of the collimating lens 13 can be designed and customized according to actual needs (e.g., a cylinder, a half cylinder, etc.), which is not limited herein.

Preferably, the fixing member 14 is glue. It can be understood that since multiple lasers 12 are densely distributed on the front surface 111 of the emitting circuit board 11, there is no suitable space on the front surface 111 of the emitting circuit board 11 for glue dispensing, and glue is easy to penetrate into the lasers 12, which may cause the laser beams emitted by the lasers 12 to be not bright or to have reduced brightness. Therefore, the disclosure adopts a glue dispensing method of fixing the collimating lens 13 to the back surface 112 of the emitting circuit board 11, without considering the influence on the multiple lasers 12 and having sufficient space for glue dispensing, thereby reducing the difficulty of the glue dispensing process and saving time cost.

Referring to FIG. 4, FIG. 4 is a schematic electrical connection diagram of a collimation system of a LiDAR device according to an embodiment. The disclosure further provides a collimation system 2 for the LiDAR device 1, to collimate the LiDAR device 1 through the collimation system 2. The collimation system 2 of the LiDAR device 1 includes an image acquisition device 21, an adjustment frame 23, and a controller 22. The controller 22 is communicatively connected to the adjustment frame 23 and the image acquisition device 21 respectively. The image acquisition device 21 is configured to acquire a spot image corresponding to a spot array formed by laser beams emitted by the plurality of lasers 12. The spot image is used to collimate the plurality of lasers 12 according to predetermined collimation conditions. The collimating lens 13 is mounted on the adjustment frame 23. The controller 22 receives the spot image collected by the image acquisition device 21 in real time, and controls movement of the adjustment frame 23 based on the spot image to drive the collimating lens 13 to move and/or rotate relative to the plurality of lasers 12, thereby adjusting the spot array. In this embodiment, the predetermined alignment conditions include coincidence of a geometric center of the spot array formed by the plurality of lasers 12 with a predetermined center, parallelism of a line on which the spot array lies with a horizontal line, and central symmetric distribution of spots in the spot array.

The adjustment frame 23 includes a clamp 232 and a driving device 231. The clamp 232 is configured to clamp the collimating lens 13. The driving device 231 is communicatively connected to the controller 22. The driving device 231 is configured to drive the clamp 232 under control of the controller 22 to move and/or rotate the collimating lens 13 relative to the plurality of lasers 12, thereby adjusting a relative position and/or a relative angle between the collimating lens 13 and the plurality of lasers 12. The adjustment frame 23 in this embodiment is a six-dimensional adjustment frame 23, which can drive the collimating lens 13 to move in six directions: x, y, z, βx, βy, and βz. Among them, the adjustment frame 23 drives the collimating lens 13 to move along x, y, and z directions, and rotate along βx, βy, and βz directions.

Referring to FIG. 8, FIG. 8 is a schematic flowchart of a collimation method of a LiDAR device according to an embodiment. The disclosure further provides a collimation method for the LiDAR device 1. The method includes steps S101 to S105.

Step S101: Acquiring a spot image of the plurality of lasers through the image acquisition device.

In step S101, both the image acquisition device 21 and the adjustment frame 23 are communicatively connected to the controller 22. The image acquisition device 21 collects a spot image of the plurality of lasers 12 in real time and transmits the spot image to the controller 22. The controller 22 adjusts a position and an angle of the collimating lens 13 relative to the plurality of lasers 12 based on the spot image. Since the spot image changes with the position and angle of the collimating lens 13 relative to the plurality of lasers 12, the spot image acquired by the image acquisition device 21 in real time includes a spot image corresponding to an unadjusted spot array and a spot image corresponding to an adjusted spot array.

In another feasible embodiment, an operator directly observes the spot image of the plurality of lasers 12 through the image acquisition device 21 to determine whether laser beams of the plurality of lasers 12 deviate. The operator manually operates the controller 22 to control movement of the adjustment frame 23 based on a judgment result. Specifically, a control device (e.g., a button, a switch, a knob, or a touch screen) communicatively connected to the controller 22 may be provided. The operator sends a control instruction to the controller 22 by operating the control device. The controller 22 then controls the adjustment frame 23 to move to change the position and angle of the collimating lens 13 according to the control instruction, thereby adjusting a transmission direction of laser beams emitted by the lasers 12. It can be understood that during adjustment, the operator observes a state of the spot array based on the unadjusted spot image, and adjusts the position and angle of the collimating lens 13 according to the state of the spot array to continuously acquire the adjusted spot image until the spot array in the adjusted spot image all meets the predetermined alignment conditions.

Step S103: adjusting the position and angle of the collimating lens relative to the plurality of lasers based on the spot image until spots corresponding to the plurality of lasers all satisfy predetermined alignment conditions.

In step S103, the spot image is a spot array image formed by laser beams emitted by the plurality of lasers 12. The controller 22 receives the spot image and determines whether the spot array in the spot image satisfies the predetermined alignment conditions. Among them, the predetermined alignment conditions include coincidence of a geometric center of the spot array formed by the plurality of lasers 12 with a predetermined center, parallelism of a line on which the spot array lies with a horizontal line, and central symmetric distribution of spots in the spot array. Specifically, when the spot array does not satisfy the predetermined alignment conditions, the controller 22 controls the adjustment frame 23 to move to drive the collimating lens 13 to move and/or rotate relative to the plurality of lasers 12 along horizontal and vertical directions, so as to adjust the position and angle of the collimating lens 13 relative to the plurality of lasers 12. It can be understood that the position and angle of the collimating lens 13 relative to the plurality of lasers 12 need to be adjusted repeatedly to ensure that the spot array formed by laser beams of the plurality of lasers 12 satisfies the predetermined alignment conditions. When the spot array satisfies the predetermined alignment conditions, it indicates that the collimating lens 13 achieves collimation of the plurality of lasers 12 at this time, and there is no need to adjust the position and angle of the collimating lens 13 relative to the plurality of lasers 12 anymore.

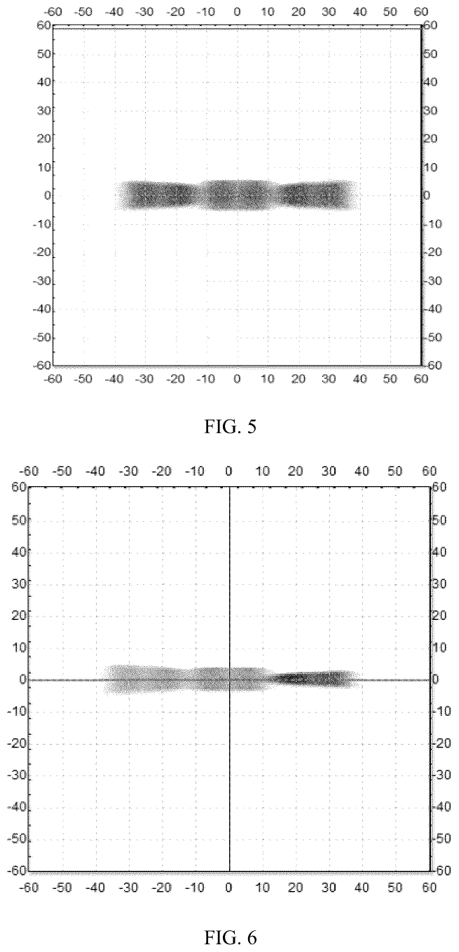

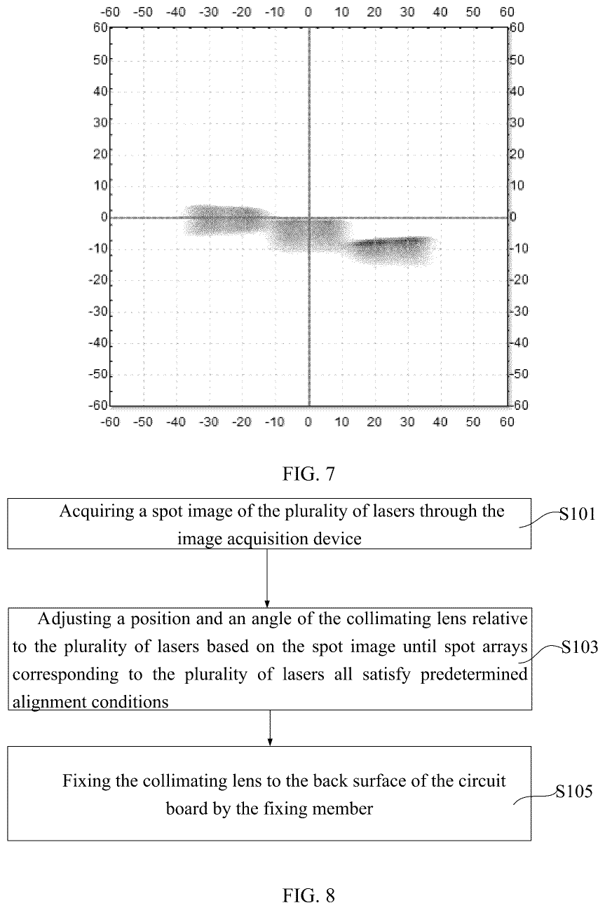

Referring to FIGS. 5-7, FIGS. 5-7 are schematic diagrams of three spot images according to an embodiment. The following describes with an example of spot images of three lasers 12. FIG. 5 is a spot image corresponding to an adjusted spot array. At this time, the spot array in the spot image satisfies the predetermined alignment conditions. That is, the collimating lens 13 has no tilt in six directions: x, y, z, βx, βy, and βz, and there is no need to adjust the position and angle of the collimating lens 13 relative to the plurality of lasers 12 through the adjustment frame 23. Both FIG. 6 and FIG. 7 are spot images corresponding to unadjusted spot arrays. Among them, FIG. 5 is a spot diagram when the collimating lens 13 is tilted in the z direction, and FIG. 6 is a spot diagram when the collimating lens 13 is tilted in the y direction. That is, the spot arrays in FIGS. 6-7 do not satisfy the predetermined alignment conditions, and it is necessary to continuously adjust the position and angle of the collimating lens 13 relative to the plurality of lasers 12 through the adjustment frame 23 until the spot array presents the state shown in FIG. 5.

Step S105: fixing the collimating lens to the back surface of the circuit board by the fixing member.

In step S105, when the spot array satisfies the predetermined alignment conditions, the collimating lens 13 is fixed to the back surface 112 of the emitting circuit board 11 by the fixing member 14. Preferably, the fixing member 14 is glue, and automatic glue dispensing can be performed through an automatic glue dispensing device (not shown), or manual glue dispensing can be performed, which is not limited herein. It can be understood that since no laser 12 is disposed on the back surface 112 of the emitting circuit board 11, fixing the collimating lens 13 to the emitting circuit board 11 does not need to consider the influence on the lasers 12, thereby reducing the difficulty of the glue dispensing process and saving time cost.

In the above embodiments, multiple lasers 12 are arranged on the front surface 111 of the emitting circuit board 11. By adjusting the position and angle of the collimating lens 13 relative to the multiple lasers 12, simultaneous collimation of multiple lasers 12 is achieved through one collimating lens 13. When the collimating lens 13 achieves collimation of the multiple lasers 12, the collimating lens 13 is fixed to the back surface 112 of the emitting circuit board 11. Since only one collimating lens 13 needs to be fixed without considering the influence on the multiple lasers 12, the difficulty of fixing the collimating lens 13 is reduced, thereby reducing time cost.

Apparently, those skilled in the art can make various modifications and variations to the present application without departing from the spirit and scope of the present application. Therefore, if these modifications and variations of the present application fall within the scope of the claims of the present application and their equivalents, the present application also intends to include these modifications and variations.

The above enumerated embodiments are merely preferred embodiments of the present application, and of course, cannot be used to limit the scope of the claims of the present application. Therefore, equivalent variations made according to the claims of the present application still fall within the scope encompassed by the present application.

1. A LiDAR device, wherein the LiDAR device comprises:
an emitting circuit board, having a front surface and a back surface opposite to the front surface;
a plurality of lasers, arranged on the front surface; and
a collimating lens, positioned adjacent to the front surface and spaced apart from the plurality of lasers by a predetermined distance; the plurality of lasers oriented towards the collimating lens, with the axial length of the collimating lens being greater than the distance between any two adjacent lasers, such that when the plurality of lasers emit laser beams, a spot array is formed via the collimating lens; and the collimating lens being coupled to the emitting circuit board by a fixing member secured to the back surface.

2. The LiDAR device according to claim 1, wherein the lasers are arranged in a planar array parallel to an entrance surface of the collimating lens; each laser has a beam axis tilted at a predetermined angle relative to an optical axis of the collimating.

3. The LiDAR device according to claim 1, wherein a center-to-center spacing variation between any two adjacent lasers is maintained within a predetermined value in both horizontal and vertical directions.

4. The LiDAR device according to claim 1, wherein the plurality of lasers are edge-emitting lasers.

5. The LiDAR device according to claim 1, wherein the fixing member is glue.

6. A collimation system for a LiDAR device, wherein the LiDAR device comprises an emitting circuit board, having a front surface and a back surface opposite to the front surface; a plurality of lasers, arranged on the front surface; and a collimating lens, positioned adjacent to the front surface and spaced apart from the plurality of lasers by a predetermined distance; the plurality of lasers oriented towards the collimating lens, with the axial length of the collimating lens being greater than the distance between any two adjacent lasers, such that when the plurality of lasers emit laser beams, a spot array is formed via the collimating lens; and the collimating lens being coupled to the emitting circuit board by a fixing member secured to the back surface, the collimation system comprises:
an image acquisition device, configured to acquire a spot image corresponding to the spot array formed by laser beams emitted by the plurality of lasers, the spot image being configured to collimate the plurality of lasers according to predetermined collimation conditions;
an adjustment frame, on which the collimating lens is mounted, configured to drive the collimating lens to move and/or rotate relative to the plurality of lasers; and
a controller, communicatively connected to the adjustment frame and the image acquisition device respectively; the controller controlling movement of the adjustment frame based on the spot image to drive the collimating lens to move and/or rotate relative to the plurality of lasers, thereby adjusting the spot array.

7. The collimation system according to claim 6, wherein the predetermined collimation conditions includes: coincidence of a geometric center of the spot array with a predetermined collimation center, parallelism of a line on which the spot array lies with a predetermined collimation line, and central symmetric distribution of spots in the spot array.

8. The collimation system according to claim 6, wherein the adjustment frame comprises a clamp, and a driving device, the clamp is configured to clamp the collimating lens, and the driving device is communicatively coupled to the controller; the driving device is configured to drive the clamp to move and/or rotate the collimating lens relative to the plurality of lasers under control of the controller, thereby adjusting a relative position and/or a relative angle between the collimating lens and the plurality of lasers.

9. The collimation system according to claim 6, wherein the lasers are arranged in a planar array parallel to an entrance surface of the collimating lens; each laser has a beam axis tilted at a predetermined angle relative to an optical axis of the collimating.

10. The collimation system according to claim 6, wherein a center-to-center spacing variation between any two adjacent lasers is maintained within a predetermined value in both horizontal and vertical directions.

11. The collimation system according to claim 6, wherein the plurality of lasers are edge-emitting lasers.

12. The collimation system according to claim 6, wherein the fixing member is glue.

13. A collimation method for a LiDAR device, the collimation method comprising:
acquiring a spot image of the plurality of lasers by an image acquisition device;
adjusting a position and an angle of the collimating lens relative to the plurality of lasers based on the spot image until spot arrays corresponding to the plurality of lasers all satisfy predetermined alignment conditions; and
fixing the collimating lens to the back surface of the emitting circuit board by the fixing member.

14. The collimation method according to claim 9, wherein adjusting the position and the angle of the collimating lens relative to the plurality of lasers based on the spot image until spots corresponding to the plurality of lasers all satisfy the predetermined alignment conditions specifically comprises:
observing whether a spot array satisfies the predetermined alignment conditions, via the spot image; and
when the spot array does not satisfy the alignment conditions, controlling an adjustment frame to move to drive the collimating lens to move and/or rotate relative to the plurality of lasers along horizontal and vertical directions, so as to adjust the position and the angle of the collimating lens relative to the plurality of lasers until the spot array satisfies the predetermined alignment conditions.

15. The collimation method according to claim 13, wherein the lasers are arranged in a planar array parallel to an entrance surface of the collimating lens; each laser has a beam axis tilted at a predetermined angle relative to an optical axis of the collimating.

16. The collimation method according to claim 13, wherein a center-to-center spacing variation between any two adjacent lasers is maintained within a predetermined value in both horizontal and vertical directions.

17. The collimation method according to claim 13, wherein the plurality of lasers are edge-emitting lasers.

18. The collimation method according to claim 13, wherein the fixing member is glue.

19. The collimation method according to claim 13, wherein the predetermined collimation conditions include: coincidence of a geometric center of the spot array with a predetermined collimation center, parallelism of a line on which the spot array lies with a predetermined collimation line, and central symmetric distribution of spots in the spot array.

20. The collimation method according to claim 19, wherein the adjustment frame comprises a clamp, and a driving device, the clamp is configured to clamp the collimating lens, and the driving device is communicatively coupled to the controller; the driving device is configured to drive the clamp to move and/or rotate the collimating lens relative to the plurality of lasers under control of the controller, thereby adjusting a relative position and/or a relative angle between the collimating lens and the plurality of lasers.
